(19) United States
(12) Patent Application Publication
(10) Pub. No.: US 2026/0089545 A1
(43) Pub. Date: Mar. 26, 2026

(54) Electronic Devices, Methods and Systems for Determining Indoor or Outdoor Positioning Using Communication Data Rates and Feedback Matrix Transmission Intervals

(71) Applicant: Motorola Mobility LLC, Chicago, IL (US)

(72) Inventors: Prashanth Chakravarthy, Bangalore (IN); Ranjeet Gupta, Aurora, IL (US)

(21) Appl. No.: 18/891,709

(22) Filed: Sep. 20, 2024

(51) Int. Cl. H04W 28/02; H04B 7/0417; H04W 84/12

(52) U.S. Cl. CPC H04W 28/0231; H04B 7/0417; H04W 84/12

(57) ABSTRACT

An electronic device determines whether the device is situated indoors or outdoors by analyzing communication data rates and feedback matrix transmission intervals. One or more processors assess if the communication data rate with an access point exceeds a threshold. If so, the processors obtain the feedback matrix transmission interval. When this interval exceeds another threshold, the device is determined to be indoors; otherwise, the device is outdoors. The device can switch communication channels based on this determination, ensuring compliance with regulatory requirements and optimizing performance. The device may also use ultra-wideband or Bluetooth.sup.™ processes to determine the location of other electronic devices and store this information in a database.

### BACKGROUND

### Technical Field

This disclosure relates generally to electronic devices, and more particularly to electronic devices employing multiple input-multiple output (MIMO) antenna arrays.

### Background Art

Portable electronic communication devices, especially smartphones, have become ubiquitous. People all over the world use such devices to stay connected. Many electronic devices today use MIMO antenna arrays to communicate across a network. While MIMO antenna arrays allow for incredibly fast data throughput rates when working optimally, their performance can degrade under certain conditions. Illustrating by example, it can sometimes be difficult to determine whether a given electronic device is indoors our outdoors. This determination can be important for optimizing the use of communication channels, particularly in the six GHz band, which has specific regulatory requirements for indoor and outdoor usage. The inability to accurately identify the device's environment can lead to suboptimal performance and potential regulatory violations. It would be advantageous to have an improved electronic device capable of better determining whether it was indoors or out.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory environment having indoor locations and outdoor locations in accordance with one or more embodiments of the disclosure.

FIG. 3 illustrates one explanatory method in accordance with one or more embodiments of the disclosure.

FIG. 4 illustrates another explanatory method in accordance with one or more embodiments of the disclosure.

FIG. 5 illustrates still another explanatory method in accordance with one or more embodiments of the disclosure.

FIG. 6 illustrates one or more method steps in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, by one or more processors from signals from a communication device operable with the one or more processors, whether a communication data rate with an access point exceeds a threshold and, when the communication data rate exceeds the threshold, obtaining, by the one or more processors from a memory operable with the one or more processors, a feedback matrix transmission interval occurring between instances of the communication device transmitting a feedback matrix to the access point and, when the feedback matrix transmission interval exceeds another threshold, determining, by the one or more processors, that the electronic device is situated indoors. In one or more embodiments, when the feedback matrix transmission interval is below the another threshold, the method can comprise determining, by the one or more processors, that the electronic device is situated outdoors.

Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic signal data exchange with remote electronic devices.

It will be appreciated that embodiments of the disclosure described herein may be comprised of one or more conventional processors and unique stored program instructions that control the one or more processors to implement, in conjunction with certain non-processor circuits, some, most, or all of the functions of, when the communication device supports multiple input/multiple output (MIMO) communication and is electronically communicating with an access point with a communication data rate exceeding a communication data rate threshold, determining whether a feedback matrix transmission interval occurring between instances of the communication device transmitting a feedback matrix to the access point indicates that the electronic device is situated indoors or is situated outdoors as described herein. The non-processor circuits may include, but are not limited to, a radio receiver, a radio transmitter, signal drivers, clock circuits, power source circuits, and user input devices.

As such, these functions may be interpreted as steps of a method to perform determining, by one or more processors from signals from a communication device operable with the one or more processors, whether a communication data rate with an access point is within a predefined data rate range and, when the communication data rate is within the predefined data rate range, obtaining, by the one or more processors from a memory operable with the one or more processors, a feedback matrix transmission interval occurring between instances of the communication device transmitting a feedback matrix to the access point. In one or more embodiments, when the feedback matrix transmission interval is exceeds a transmission interval threshold, the method comprises determining, by the one or more processors, that the electronic device is situated indoors, while when the feedback matrix transmission interval is below the transmission interval threshold, the method comprises determining by the one or more processors, that the electronic device is situated outdoors.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on. ” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, electronic devices capable of Wireless Local Area Network (WLAN) communication often face challenges in determining whether they are located indoors or outdoors. As also noted above, this determination is important for optimizing the use of communication channels, particularly in the six GHz band, which has specific regulatory requirements for indoor and outdoor usage. The inability to accurately identify the device's environment can lead to suboptimal performance and potential regulatory violations.

Existing methods for determining whether a device is indoors or outdoors rely on various techniques such as location detection (e.g., via the Global Positioning System (GPS)), various sensors, ambient light, and even the Wi-Fi Received Signal Strength Indicator (RSSI). These methods have significant drawbacks.

For instance, location detection via GPS signals may not be available indoors. Alternatively, location detection indoors via GPS can be inaccurate due to signal reflections. Sensors that attempt to determine whether the electronic device is indoors or outdoors can be uncalibrated, which leads to erroneous readings. Ambient light detection can be affected by weather conditions or artificial lighting, causing false positives. Wi-Fi RSSI is not a reliable indicator due to propagation characteristics, which can vary significantly based on the environment.

Advantageously, embodiments of the disclosure provide solutions to these problems. In one or more embodiments, methods in accordance with embodiments of the disclosure address these challenges by leveraging the capabilities of Multiple Input Multiple Output (MIMO) technology to determine whether an electronic device capable of MIMO communication is indoors or outdoors. In one or more embodiments, by analyzing the Modulation Coding Scheme (MCS) communication data rate and the time taken to send a feedback matrix in response to a beamforming report, the method provides a reliable way to identify the device's environment, namely, whether the electronic device is situated indoors or outdoors. Advantageously, this approach allows the electronic device to switch between indoor and outdoor communication channels, thereby ensuring compliance with regulatory requirements and optimizing performance.

In one or more embodiments, a method in an electronic device involves determining, by one or more processors from signals from a communication device operable with the one or more processors, whether a communication data rate with an access point exceeds a threshold. When the communication data rate exceeds the threshold, the method includes obtaining, by the one or more processors from a memory operable with the one or more processors, a feedback matrix transmission interval occurring between instances of the communication device transmitting a feedback matrix to the access point. When the feedback matrix transmission interval exceeds another threshold, the method further includes determining, by the one or more processors, that the electronic device is situated indoors.

In this method, the communication data rate serves as an initial filter to assess the quality of the connection. Only when the communication data rate exceeds a predefined threshold does the method proceed to evaluate the feedback matrix transmission interval. This two-step process reduces the likelihood of errors in determining the device's environment, thereby enhancing the accuracy of the location determination. The feedback matrix transmission interval, which is influenced by the number of signal reflections in the environment, serves as an indicator of whether the device is indoors or outdoors.

By determining whether a communication data rate with an access point exceeds a threshold, the method allows the electronic device to assess the quality of the connection, which is crucial for accurate location determination. This step ensures that the device only proceeds with further location-based operations when the connection is reliable, thereby reducing the likelihood of errors in subsequent steps.

Obtaining a feedback matrix transmission interval occurring between instances of the communication device transmitting a feedback matrix to the access point provides a reliable metric for distinguishing between indoor and outdoor environments. The feedback matrix transmission interval is influenced by the number of signal reflections in the environment, which tend to be higher indoors due to multiple reflections off walls and other objects. This results in a longer transmission interval indoors compared to outdoors, where there are fewer reflections.

When the feedback matrix transmission interval exceeds another threshold, the method determines that the electronic device is situated indoors. This determination is based on the observation that indoor environments typically have more signal reflections, leading to longer feedback matrix transmission intervals. Conversely, shorter intervals are indicative of outdoor environments with fewer reflections. This approach leverages the inherent characteristics of MIMO technology to provide a more accurate and reliable method for determining the device's environment compared to traditional methods such as GPS or RSSI, which can be unreliable or inaccurate under certain conditions.

In one or more embodiments, an electronic device comprises a communication device and one or more processors operable with the communication device. When the communication device supports MIMO communication and is electronically communicating with an access point with a communication data rate exceeding a communication data rate threshold, the one or more processors determine whether a feedback matrix transmission interval occurring between instances of the communication device transmitting a feedback matrix to the access point indicates that the electronic device is situated indoors or is situated outdoors. In one or more embodiments, the one or more processors determine that the electronic device is situated indoors when the feedback matrix transmission interval is more than three times an average outdoor feedback matrix transmission interval.

In one or more embodiments, the electronic device further comprises an ultra-wideband component. When the one or more processors determine the electronic device has transitioned from outdoors to indoors, in one or more embodiments the one or more processors cause the ultra-wideband component to determine a location of at least one other electronic device using an ultra-wideband ranging process.

When the one or more processors determine the electronic device has transitioned from outdoors to indoors, the one or more processors can cause the communication device to determine one or more other locations of one or more other electronic devices situated within the environment of the electronic device. In one or more embodiments, this location determination uses RSSI measurements of one or more communication signals received by the communication device from the one or more other electronic devices.

In one or more embodiments, the one or more processors are further configured to cause the communication device to switch communication from one or more channels allocated for outdoor communication to one or more other communication channels allocated for indoor communication when the feedback matrix transmission interval indicates the electronic device is indoors. Alternatively, the one or more processors and cause the communication device to switch communication from the one or more other channels allocated for indoor communication to the one or more channels allocated for outdoor communication when the feedback matrix transmission interval indicates that the electronic device is outdoors.

In one or more embodiments, the one or more processors are further configured to again determine whether the feedback matrix transmission interval occurring between instances of the communication device transmitting the feedback matrix to the access point indicates that the electronic device is situated indoors or is situated outdoors when the electronic device moves more than a predefined distance. This “repeat” of the measurement based upon changes in location ensures that the electronic device continually switches between indoor and outdoor communication channels properly as the device moves, thereby ensuring compliance with regulatory requirements and optimizing performance.

To better understand embodiments of the disclosure described below, it can be beneficial to understand beamforming reports. Beamforming reports are a component in wireless communication systems, particularly those employing MIMO technology. To understand beamforming reports, understanding the concept of beamforming itself is necessary.

Beamforming is a signal processing technique used in wireless communication to direct the transmission or reception of signals in specific directions. This technique enhances signal quality and data rates by focusing the signal energy towards the intended receiver, rather than broadcasting the signal energy in directions. Beamforming relies on the use of multiple antennas to create a directional signal, which can be adjusted dynamically based on the environment and the location of the receiver.

In the context of MIMO systems, beamforming involves the use of multiple antennas at both the transmitter (e.g., an access point) and the receiver (e.g., a mobile device). The transmitter sends out signals that bounce off various objects in the environment, creating multiple signal paths. The receiver captures these signals and uses them to compute a beamforming matrix, which is a mathematical representation of the optimal way to combine the signals to improve communication quality.

Beamforming reports (BFRs) are the feedback provided by the receiver to the transmitter, containing information about the computed beamforming matrix. These reports help the transmitter adjust the signal transmission to optimize the signal quality and data rate. The process typically involves the following steps:

The first step is the step of signal transmission. In the signal transmission step, the transmitter sends out signals using multiple antennas. These signals travel through the environment, reflecting off various objects and creating multiple paths.

The second step is that of signal reception. During signal reception, the receiver captures the incoming signals using the receiver's multiple antennas. The receiver then estimates the MIMO channel matrix, which represents the signal paths between the transmitter and receiver antennas.

Next comes beamforming matrix computation. In this step, the receiver uses the estimated MIMO channel matrix to compute the beamforming matrix. This matrix indicates how the signals are combined to optimize the communication quality.

Thereafter, feedback transmission occurs. In feedback transmission, the receiver sends the beamforming report, containing the computed beamforming matrix, back to the transmitter. This feedback is typically sent in the form of a feedback matrix.

Next is signal adjustment where the transmitter uses the information in the beamforming report to adjust the signal transmission. By doing so, the transmitter can focus the signal energy towards the receiver, improving the signal quality and data rate.

In summary, beamforming reports are feedback mechanisms in MIMO systems that enable the transmitter to optimize signal transmission based on the receiver's environment. These reports contain information about the computed beamforming matrix, which helps the transmitter adjust the signal direction and improve communication quality.

In one or more embodiments, a method in an electronic device comprises determining, by one or more processors from signals from a communication device operable with the one or more processors, whether a communication data rate with an access point is within a predefined data rate range. In one or more embodiments, this involves assessing the quality of the connection between the electronic device and the access point.

In one or more embodiments, the communication data rate serves as an initial filter to evaluate the connection's reliability. This step ensures that the device only proceeds with further location-based operations when the connection is stable, thereby reducing the likelihood of errors in subsequent steps. The predefined data rate range is established based on empirical data, which indicates typical indoor and outdoor communication data rates. By comparing the current communication data rate with this predefined range, the method can accurately determine whether the device is likely to be indoors or outdoors.

When the communication data rate is within the predefined data rate range, the method includes obtaining, by the one or more processors from a memory operable with the one or more processors, a feedback matrix transmission interval occurring between instances of the communication device transmitting a feedback matrix to the access point. The feedback matrix transmission interval is influenced by the number of signal reflections in the environment, which tend to be higher indoors due to multiple reflections off walls and other objects. This results in a longer transmission interval indoors compared to outdoors, where there are fewer reflections. By analyzing this interval, the method provides a reliable metric for distinguishing between indoor and outdoor environments.

When the feedback matrix transmission interval exceeds a transmission interval threshold, the method further includes determining, by the one or more processors, that the electronic device is situated indoors. When the feedback matrix transmission interval is below the transmission interval threshold, the method comprises determining, by the one or more processors, that the electronic device is situated outdoors. This determination leverages the characteristics of MIMO technology to provide a more accurate and reliable method for identifying the device's environment compared to traditional methods such as GPS or RSSI, which can be unreliable or inaccurate under certain conditions.

In one or more embodiments, the method comprises storing, by the one or more processors, an electronic device situation location in a memory of the electronic device ensures that the device maintains a record of the environment. This stored information can be used for various purposes, such as optimizing future communication channel selections or enhancing the accuracy of subsequent location determinations. By maintaining a history of the device's environment, the method can improve the overall performance and reliability of the electronic device's communication capabilities.

By incorporating a communication device and one or more processors operable with the communication device, electronic devices in accordance with embodiments of the disclosure can effectively determine whether it is situated indoors or outdoors based on the feedback matrix transmission interval. This arrangement leverages the inherent characteristics of MIMO technology, where the feedback matrix transmission interval is influenced by the number of signal reflections in the environment. Indoors, multiple reflections off walls and other objects result in longer transmission intervals, while outdoors, fewer reflections lead to shorter intervals. This method provides a more accurate and reliable determination of the device's environment compared to traditional methods such as GPS or RSSI, which can be unreliable or inaccurate under certain conditions.

When the communication device supports MIMO communication and is electronically communicating with an access point with a communication data rate exceeding a communication data rate threshold, the one or more processors can determine whether the feedback matrix transmission interval indicates that the electronic device is situated indoors or outdoors. This capability ensures that the device can dynamically switch between indoor and outdoor communication channels, thereby optimizing performance and ensuring compliance with regulatory requirements. For instance, when the feedback matrix transmission interval is more than three times an average outdoor feedback matrix transmission interval, the device can accurately determine that it is indoors, allowing it to switch to indoor communication channels for better efficiency and throughput.

This method also enhances the overall user experience by providing seamless transitions between indoor and outdoor environments without manual intervention. The ability to automatically switch communication channels based on the device's environment ensures that the device always operates on the most appropriate channel, reducing interference and improving data rates. This is particularly beneficial for applications that require high data throughput and low latency, such as video streaming, online gaming, and real-time communication. Other advantages will be described below. Still others will be obvious to those of ordinary skill in the art having the benefit of this disclosure.

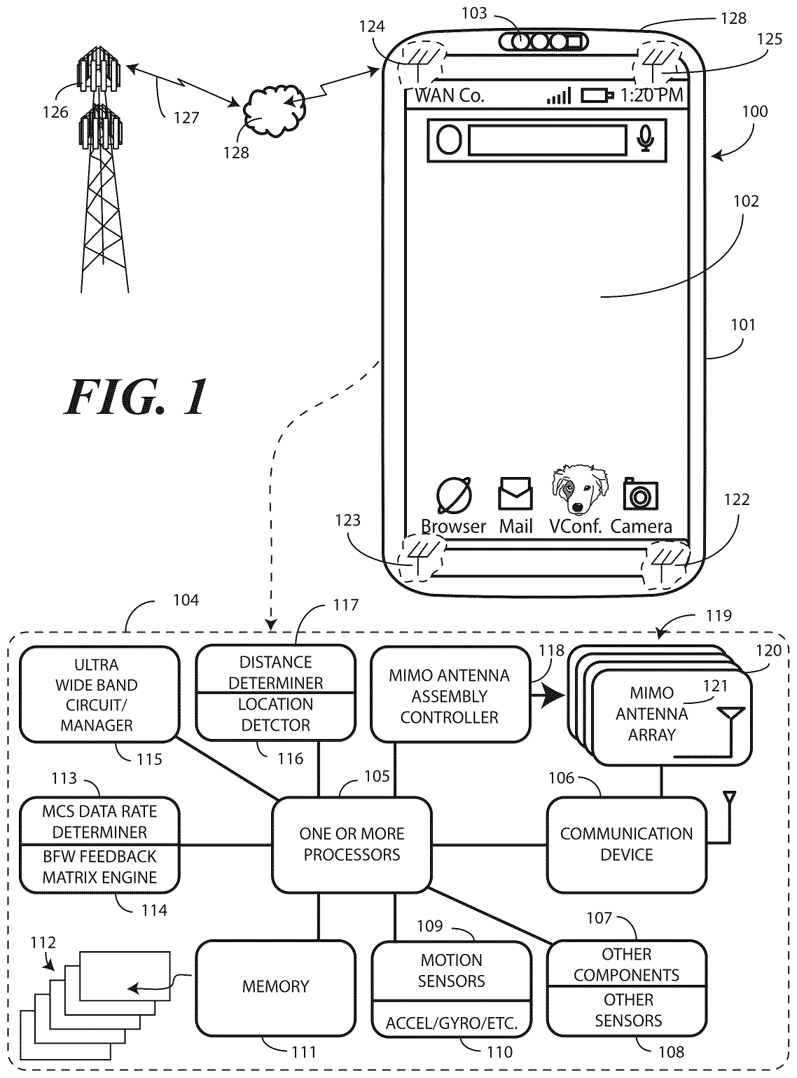

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, laptop computers, desktop computers, servers, networked computers, multimedia players, and so forth. Still other types of electronic devices can be configured in accordance with one or more embodiments of the disclosure as will be readily appreciated by those of ordinary skill in the art having the benefit of this disclosure.

The electronic device 100 includes a device housing 101. In one or more embodiments the device housing 101 is manufactured from a rigid material such as a rigid thermoplastic, metal, or composite material, although other materials can be used. Still other constructs will be obvious to those of ordinary skill in the art having the benefit of this disclosure. In the illustrative embodiment of FIG. 1, the electronic device 100 includes a single device housing 101. However, in other embodiments two or more device housings can be included.

Illustrating by example, in other embodiments an electronic device includes a first device housing and a second device housing. In one or more embodiments, a hinge assembly couples the first device housing to the second device housing. In one or more embodiments, the first device housing is selectively pivotable about the hinge assembly relative to the second device housing. For example, in one or more embodiments the first device housing is selectively pivotable about the hinge assembly between a closed position and an axially displaced open position. In still other embodiments, multiple hinges can be incorporated into the electronic device to allow it to be folded in multiple locations.

This illustrative electronic device 100 of FIG. 1 includes a display 102. The display 102 can optionally be touch-sensitive. In one embodiment where the display 102 is touch-sensitive, the display 102 can serve as a primary user interface of the electronic device 100. Users can deliver user input to the display 102 of such an embodiment by delivering touch input from a finger, stylus, or other objects disposed proximately with the display 102.

In one embodiment, the display 102 is configured as an organic light emitting diode (OLED) display fabricated on a substrate. Where the electronic device is flexible, the substrate can comprise flexible plastic substrate, thereby making the display 102 a flexible display or foldable display that deforms when the first device housing pivots about the hinge assembly relative to the second device housing.

Features can be incorporated into the device housing 101. Examples of such features include an image capture device 103 or an optional speaker port. A user interface component, which may be a button or touch sensitive surface, can also be disposed along the device housing 101. Other features can be added as well.

A block diagram schematic 104 of the electronic device 100 is also shown in FIG. 1. The block diagram schematic 104 can be configured as a printed circuit board assembly disposed within the device housing 101 of the electronic device 100. Various components can be electrically coupled together by conductors, or a bus disposed along one or more printed circuit boards.

It should be noted that the block diagram schematic 104 includes many components that are optional, but which are included in an effort to demonstrate how varied electronic devices configured in accordance with embodiments of the disclosure can be. Thus, it is to be understood that the block diagram schematic 104 of FIG. 1 is provided for illustrative purposes only and for illustrating components of one electronic device 100 in accordance with embodiments of the disclosure.

The block diagram schematic 104 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components, and still be within the scope of the present disclosure.

In one or more embodiments, the electronic device 100 includes one or more processors 105. The one or more processors 105 can be a microprocessor, a group of processing components, one or more Application Specific Integrated Circuits (ASICs), programmable logic, or other type of processing device. The one or more processors 105 can be operable with the various components of the electronic device 100. The one or more processors 105 can be configured to process and execute executable software code to perform the various functions of the electronic device 100. A storage device, such as memory 111, can optionally store the executable software code used by the one or more processors 105 during operation.

In one or more embodiments, the one or more processors 105 are further responsible for performing the primary functions of the electronic device 100. For example, in one embodiment the one or more processors 105 comprise one or more circuits operable to present presentation information, such as images, text, and video, on the display 102. The executable software code used by the one or more processors 105 can be configured as one or more modules 112 that are operable with the one or more processors 105. Such modules 112 can store instructions, control algorithms, and so forth.

In one embodiment, the one or more processors 105 are responsible for running an operating system environment. The operating system environment can include a kernel, one or more drivers, and an application service layer, and an application layer. The operating system environment can be configured as executable code operating on one or more processors or control circuits of the electronic device 100.

In one or more embodiments, the one or more processors 105 are responsible for managing the applications of the electronic device 100. In one or more embodiments, the one or more processors 105 are also responsible for launching, monitoring, and killing the various applications and the various application service modules. The applications of the application layer can be configured as clients of the application service layer to communicate with services through application program interfaces (APIs), messages, events, or other inter-process communication interfaces.

In this illustrative embodiment, the electronic device 100 also includes a communication device 106 that can be configured for wired or wireless communication with one or more other devices or networks. The networks can include a wide area network, a local area network, and/or personal area network. The communication device 106 may also utilize wireless technology for communication, such as, but are not limited to, peer-to-peer or ad hoc communications, and other forms of wireless communication such as infrared technology. The communication device 106 can include wireless communication circuitry, one of a receiver, a transmitter, or transceiver, and one or more antennas 120.

The one or more antennas 120 can take a variety of forms. Illustrating by example, in one or more embodiments using 5G communication as an example, the one or more antennas 120 can comprise a MIMO antenna array 119 comprising a plurality of wireless communication subsystems 122,123,124,125 configured for MIMO communication 127 with other remote electronic devices, servers, base stations 126, and so forth, across a network 128. In other embodiments, each of the wireless communication subsystems 122,123,124,125 can comprise mm Wave wireless communication subsystems.

In one or more embodiments, a MIMO antenna array 119 consists of four wireless communication subsystems 122,123,124,125. While four wireless communication subsystems 122,123,124,125 can define a MIMO antenna array 119 comprising one or more MIMO antenna assemblies 121 or a mm Wave system in some embodiments, additional wireless communication subsystems can be included at other locations. Illustrating by example, embodiments of the disclosure can be equipped with six antenna elements, eight antenna elements, or higher numbers of antenna elements, located at different locations as well. Other configurations will be obvious to those of ordinary skill in the art having the benefit of this disclosure.

In one or more embodiments, the one or more antennas 120 also include multiple mm Wave antenna assemblies. In one or more embodiments, each mm Wave antenna assembly comprises an array of mm Wave antenna elements. In other embodiments, each mm Wave antenna assembly comprises a single mm Wave antenna element. Other examples of mm Wave antenna assemblies configured in accordance with embodiments of the disclosure will be obvious to those of ordinary skill in the art having the benefit of this disclosure.

In one or more embodiments, the block diagram schematic 104 includes an ultra-wideband component 115. In one or more embodiments, the ultra-wideband component 115 is similar to the communication device 106 in that it is configured to perform wireless communications with one or more other ultra-wideband components that may be integrated into, or attached to, other devices.

The illustrative ultra-wideband component of FIG. 1 is a dedicated ultra-wideband transceiver constructed into the electronic device 100 configured to use the one or more antennas 120 or its own antenna structure to communicate, using ultra-wideband technology, with another ultra-wideband component. In one or more embodiments, the ultra-wideband component comprises wireless communication circuitry, one of a receiver, a transmitter, or transceiver, and one or more antennas, which may be separate from, or the same as, the one or more antennas 120 used by the communication device 106. While the ultra-wideband component 115 is separated from the communication device 106 in the block diagram schematic 104 of FIG. 1, embodiments of the disclosure contemplate that they can be integrated together, as described above.

The inclusion of an ultra-wideband component 115 advantageously allows wireless communication with another ultra-wideband component connected to or integrated into another electronic device that is fast and secure, all while requiring very little power. In one or more embodiments, the ultra-wideband component 115 consumes at least an order of magnitude less energy than does the communication device 106. Ultra-wideband communication is especially well suited to embodiments of the disclosure because it is configured for short-range (within 250 meters) communication, which is satisfactory for applications such as the methods described below.

Additionally, the accuracy of location, and therefore the accuracy of distance measurements, is within a centimeter or less. This is in contrast to Bluetooth. sup. TM which has an accuracy range of between one and five meters, and is far better than Wi-Fi, which has an accuracy of five to fifteen meters.

Ultra-wideband is also quite reliable, in that it offers strong immunity to multi-path communication channels and interference in the line of sight. It also offers exceptional bandwidth, with data communications occurring at up to 27 Mbps, which is in contrast to the 2 Mbps provided by Bluetooth.sup.™. Ultra-wideband is also very low latency, with typically latencies being less than a millisecond, which is in contrast to the several seconds of latency that can occur with Bluetooth.sup.™.

In one or more embodiments, the ultra-wideband component 115 can also be used to measure angle of arrival. Effectively, when the one or more antennas 120 are configured as an antenna array, the ultra-wideband component 115 can compare signals received from one side of the antenna array with other signals received from another side of the antenna array to determine an orientation of the electronic device 100 in three-dimensional space relative to a companion device having another ultra-wideband component attached thereto or integrated therein.

Various sensors 108 can be operable with the one or more processors 105. One example of a sensor that can be included with the various sensors 108 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 105, to detect an object in close proximity with - or touching - the surface of the display 102 or the device housing 101 of the electronic device 100 by establishing electric field lines between pairs of capacitive sensors and then detecting perturbations of those field lines.

Another example of a sensor that can be included with the various sensors 108 is a geo-locator that serves as a location detector 116. In one embodiment, location detector 116 is able to determine location data. Location can be determined by capturing the location data from a constellation of one or more earth orbiting satellites, or from a network of terrestrial base stations to determine an approximate location. The location detector 116 may also be able to determine location by locating or triangulating terrestrial base stations of a traditional cellular network, or from other local area networks, such as Wi-Fi networks.

Another example of a sensor that can be included with the various sensors 108 is an orientation detector 110 operable to determine an orientation and/or movement of the electronic device 100 in three-dimensional space. A motion detector 109 can also determine motion of the electronic device 100 in three-dimensional space.

Illustrating by example, the orientation detector 110 and/or motion detector 109 can include an accelerometer, gyroscopes, or other device to detect device orientation and/or motion of the electronic device 100. Using an accelerometer as an example, an accelerometer can be included to detect motion of the electronic device 100. Additionally, the accelerometer can be used to sense some of the gestures of the user, such as one talking with their hands, running, or walking.

The orientation detector 110 can determine the spatial orientation of an electronic device 100 in three-dimensional space by, for example, detecting a gravitational direction. In addition to, or instead of, an accelerometer, an electronic compass can be included to detect the spatial orientation of the electronic device 100 relative to the earth's magnetic field. Similarly, one or more gyroscopes can be included to detect rotational orientation of the electronic device 100.

Other components 107 operable with the one or more processors 105 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 107 can also include proximity sensors. The proximity sensors fall in to one of two camps: active proximity sensors and “passive” proximity sensors. Either the proximity detector components or the proximity sensor components can be generally used for gesture control and other user interface protocols.

The other components 107 can optionally include a barometer operable to sense changes in air pressure due to elevation changes or differing pressures of the electronic device 100. The other components 107 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

A context engine can then be operable with the various sensors to detect, infer, capture, and otherwise determine persons and actions that are occurring in an environment about the electronic device 100. For example, where included one embodiment of the context engine determines assessed contexts and frameworks using adjustable algorithms of context assessment employing information, data, and events. These assessments may be learned through repetitive data analysis. Alternatively, a user may employ a menu or user controls via the display 102 to enter various parameters, constructs, rules, and/or paradigms that instruct or otherwise guide the context engine in detecting multi-modal social cues, emotional states, moods, and other contextual information. The context engine can comprise an artificial neural network or other similar technology in one or more embodiments.

In one or more embodiments, the context engine is operable with the one or more processors 105. In some embodiments, the one or more processors 105 can control the context engine. In other embodiments, the context engine can operate independently, delivering information gleaned from detecting multi-modal social cues, emotional states, moods, and other contextual information to the one or more processors 105. The context engine can receive data from the various sensors 108. In one or more embodiments, the one or more processors 105 are configured to perform the operations of the context engine.

In one or more embodiments, the electronic device 100 includes a distance determination manager 117 that is operable with the ultra-wideband component 115 to determine a precise distance (within one centimeter) of the electronic device 100 in relation to other electronic devices also having ultra-wideband components or ultra-wideband tags (the difference between a ultra-wideband component and a ultra-wideband tag is that the ultra-wideband component is integrated into an electronic device as an original component, while a ultra-wideband tag is a self-contained ultra-wideband component that can be attached to an electronic device as a retrofit item to configure a legacy electronic device to communicate via ultra-wideband technology). Illustrating by example, rather than using the location detector 116 to determine location relative to a companion electronic device, in one or more embodiments the distance determination manager 117 can determine the distance the electronic device 100 is from a companion electronic device equipped with an ultra-wideband tag within a centimeter using ultra-wideband signals.

A motion detector 109 determines when the electronic device 100 moves. As will be described in more detail below, in one or more embodiments the one or more processors 105 of the electronic device 100 determine, from signals received from a location detector 116 or the motion detector 109, whether the electronic device 100 has moved more than a threshold distance since determining whether the communication data rate with a companion access point exceeds a predefined threshold. In one or more embodiments, when the electronic device has moved more than the threshold distance since determining whether the communication data rate with the access point exceeds the threshold, the one or more processors 105 can again determine from other signals from the communication device 106 whether another communication data rate occurring after the electronic device 100 has moved more than the threshold distance exceeds the threshold.

A MIMO antenna assembly controller 118 manages the operation of a MIMO antenna array 119 in an electronic device 100. MIMO, generally speaking, comprises a technology that uses multiple antennas at both the transmitter and receiver to improve communication performance. The MIMO antenna assembly controller 118 plays a role in coordinating these antennas to optimize data transmission and reception.

In a MIMO system, multiple antennas work together to send and receive data simultaneously. This setup allows the system to handle multiple data streams at once, significantly increasing the data throughput and improving signal quality. The MIMO antenna assembly controller 118 is responsible for managing these multiple antennas and ensuring they work in harmony.

One of the primary functions of the MIMO antenna assembly controller 118 is to control the beamforming process. Beamforming is a technique that directs the transmission or reception of signals in specific directions rather than broadcasting them in all directions. By focusing the signal energy towards the intended receiver, beamforming enhances signal quality and data rates. The MIMO antenna assembly controller 118 uses information from the environment, such as the location of the receiver and the characteristics of the signal paths, to adjust the antennas'transmission patterns dynamically.

The MIMO antenna assembly controller 118 also handles the computation and transmission of feedback matrices. In a MIMO system, the receiver estimates the MIMO channel matrix, which represents the signal paths between the transmitter and receiver antennas. The receiver then computes a beamforming matrix based on this channel matrix and sends the beamforming matrix back to the transmitter as a feedback matrix. The MIMO antenna assembly controller 118 processes this feedback matrix to adjust the transmission patterns of the antennas, optimizing the signal quality and data rate.

Additionally, in one or more embodiments the MIMO antenna assembly controller 118 monitors the communication data rate and the feedback matrix transmission interval. The communication data rate indicates the quality of the connection between the electronic device 100 and the access point. The feedback matrix transmission interval, influenced by the number of signal reflections in the environment, helps determine whether the device is indoors or outdoors. The MIMO antenna assembly controller 118 uses these metrics to make decisions about switching between indoor and outdoor communication channels, ensuring compliance with regulatory requirements and optimizing performance.

In summary, the MIMO antenna assembly controller 118 in an electronic device 100 with a MIMO antenna array 119 manages the coordination of multiple antennas to enhance data transmission and reception. The MIMO antenna assembly controller 118 controls the beamforming process, handles feedback matrices, and monitors communication metrics to optimize signal quality and data rates, ensuring efficient and reliable communication in various environments.

In one or more embodiments, the electronic device 100 comprises a MCS data rate determination module 113. In one or more embodiments, the MCS data rate determination module 113 can determine the average MCS data rate by analyzing the MCS index of the data packets being transmitted and received by the electronic device 100. The MCS index is a metric that reflects the data rate, channel width, and the number of spatial streams in the device. The MCS index simplifies the understanding of the data rate by providing a standardized scale that can be compared across different devices and wireless standards.

To determine the average MCS data rate, the MCS data rate determination module 113 performs the following steps: First, during data packet monitoring the MCS data rate determination module 113 continuously monitors the data packets being transmitted and received by the electronic device 100. This involves capturing the MCS index associated with each data packet.

Next, during MCS index collection, the MCS data rate determination module 113 collects the MCS indices over a predefined period. This collection process ensures that a sufficient number of data points are gathered to calculate an accurate average. Next, during data rate calculation, for each captured MCS index, the MCS data rate determination module 113 calculates the corresponding data rate. The data rate is determined based on the MCS index, which takes into account factors such as channel width and the number of spatial streams.

During averaging, the MCS data rate determination module 113 computes the average MCS data rate by summing the individual data rates and dividing by the number of data points collected. This averaging process provides a representative value of the data rate over the monitoring period.

The MCS data rate determination module 113 can also perform threshold comparison as well. Illustrating by example, in one or more embodiments the MCS data rate determination module 113 compares the calculated average MCS data rate against predefined thresholds to determine the quality of the connection. For instance, a high average MCS data rate may indicate an indoor environment with multiple signal reflections, while a low average MCS data rate may suggest an outdoor environment with fewer reflections.

By performing these steps, the MCS data rate determination module 113 provides a reliable metric for assessing the communication quality and environment of the electronic device 100. This information can be used to optimize the device's performance and ensure compliance with regulatory requirements for indoor and outdoor communication channels.

In one or more embodiments, the electronic device includes a beamforming feedback matrix engine 114. To understand how the beamforming feedback matrix engine 114 of FIG. 1 can determine the average time interval for transmitting the beamforming feedback matrix to an access point in communication with the electronic device 100, breaking down the process into simpler terms can be beneficial.

As noted above, beamforming is a technique used in wireless communication to direct signals towards a specific receiver, improving signal quality and data rates. In a MIMO system, multiple antennas at both the transmitter (e.g., an access point) and the receiver (e.g., the electronic device 100) are used to send and receive data. The beamforming feedback matrix engine 114 plays a role in this process.

In one or more embodiments, the beamforming feedback matrix engine 114 determines the average time interval for transmitting the beamforming feedback matrix. This can occur via a plurality of interconnected steps. Other techniques will be obvious to those of ordinary skill in the art having the benefit of this disclosure.

Initially, the access point sends out signals using multiple antennas. These signals travel through the environment, reflecting off various objects and creating multiple paths.

The electronic device 100, equipped with multiple antennas, captures the incoming signals. The beamforming feedback matrix engine 114 then estimates the MIMO channel matrix, which represents the signal paths between the access point and the device's antennas.

Using the estimated MIMO channel matrix, the beamforming feedback matrix engine 114 computes the beamforming matrix. This matrix indicates how the signals are combined to optimize communication quality. In one or more embodiments, the beamforming feedback matrix engine 114 sends the computed beamforming matrix back to the access point as a feedback matrix. This feedback helps the access point adjust the signal transmission to improve signal quality and data rates.

In one or more embodiments, the beamforming feedback matrix engine 114 measures the time interval between instances of the electronic device 100 transmitting the feedback matrix to the access point. This interval is influenced by the number of signal reflections in the environment. Indoors, multiple reflections off walls and other objects result in longer transmission intervals, while outdoors, fewer reflections lead to shorter intervals.

In one or more embodiments, the beamforming feedback matrix engine 114 collects multiple time interval measurements over a predefined period. The beamforming feedback matrix engine 114 then calculates the average time interval by summing the individual intervals and dividing by the number of measurements. This average time interval provides a reliable metric for distinguishing between indoor and outdoor environments.

By analyzing the average time interval for transmitting the beamforming feedback matrix, the beamforming feedback matrix engine 114 can determine whether the electronic device 100 is situated indoors or outdoors. This information is necessary for optimizing the use of communication channels, ensuring compliance with regulatory requirements, and improving overall performance.

In one or more embodiments, the MCS data rate determination module 113 and the beamforming feedback matrix engine 114 can be used in combination to determine whether the electronic device 100 is situated indoors our outdoors. As noted above, in one or more embodiments the MCS data rate determination module 113 determines an average MCS data rate. Embodiments of the disclosure contemplate that using this metric alone to determine an indoor/outdoor status can result in false positives in situations where there are large amounts of network congestion. This is true because congestion can cause lower average MCS data rates that are misinterpreted.

Advantageously, embodiments of the disclosure use a combination of the average MCS data rate determined by the MCS data rate determination module 113 and the average time interval for transmitting the beamforming feedback matrix as determined by the beamforming feedback matrix engine 114 to determine whether the electronic device 100 is indoors or outdoors.

It should be noted that the MCS data rate determination module 113 and the beamforming feedback matrix engine 114 can each be configured as a hardware module operable with the one or more processors 105 in one or more embodiments. In other embodiments, the MCS data rate determination module 113 and the beamforming feedback matrix engine 114 are configured as software or firmware operating on the one or more processors 105. In still other embodiments, MCS data rate determination module 113 and the beamforming feedback matrix engine 114 are configured as a hardware component integrated within the one or more processors 105. Other configurations for the MCS data rate determination module 113 and the beamforming feedback matrix engine 114 will be obvious to those of ordinary skill in the art having the benefit of this disclosure.

In one or more embodiments, when the communication device 106 supports multiple input/multiple output (MIMO) communication, as is the case in FIG. 1, and is electronically communicating with an access point with a communication data rate exceeding a communication data rate threshold, the one or more processors 105 determine whether a feedback matrix transmission interval occurring between instances of the communication device 106 transmitting a feedback matrix to the access point indicates that the electronic device 100 is situated indoors or is situated outdoors. Illustrating by example, in one or more embodiments the one or more processors 105 determine that the electronic device 100 is situated indoors when the feedback matrix transmission interval is more than three times an average outdoor feedback matrix transmission interval.

The illustrative electronic device 100 of FIG. 1 further comprises an ultra-wideband component 115. In one or more embodiments, when the one or more processors 105 determine the electronic device 100 has transitioned from outdoors to indoors, the one or more processors 105 cause the ultra-wideband component 115 to determine a location of at least one other electronic device using an ultra-wideband ranging process.

In one or more embodiments, when the one or more processors 105 determine the electronic device 100 has transitioned from outdoors to indoors, the one or more processors 105 cause the communication device 106 to determine one or more other locations of one or more other electronic devices situated within the environment of the electronic device 100 using RSSIs of one or more communication signals received by the communication device 106 from the one or more other electronic devices.

In one or more embodiments, the one or more processors 105 are further configured to cause the communication device 106 to switch communication from one or more channels allocated for outdoor communication to one or more other communication channels allocated for indoor communication when the feedback matrix transmission interval indicates the electronic device 100 is indoors. Alternatively, the one or more processors 105 can cause the communication device 106 to switch communication from the one or more other channels allocated for indoor communication to the one or more channels allocated for outdoor communication when the feedback matrix transmission interval indicates that the electronic device 100 is outdoors.

In one or more embodiments, the one or more processors 105 are further configured to again determine whether the feedback matrix transmission interval occurring between instances of the communication device 106 transmitting the feedback matrix to the access point indicates that the electronic device 100 is situated indoors or is situated outdoors when the electronic device 100 moves more than a predefined distance. This ensures that the electronic device 100 continually switches between indoor and outdoor communication channels properly as the device moves, thereby ensuring compliance with regulatory requirements and optimizing performance.

In one or more embodiments, the at least one image capture device 103 is configured as an intelligent imager. Where configured as an intelligent imager, the at least one image capture device 103 can capture one or more images of environments about the electronic device 100 to determine whether the object matches predetermined criteria. For example, the at least one image capture device 103 can operate as an identification module configured with optical recognition such as image recognition, character recognition, visual recognition, facial recognition, color recognition, shape recognition and the like.

Where the electronic device includes a first device housing that is pivotable about a hinge relative to a second device housing, the one or more sensors 108 can include one or more form factor sensors configured to detect changes in a physical form factor of the electronic device.

Illustrating by example, in one embodiment, the one or more form factor sensors comprise one or more flex sensors, operable with the one or more processors 105, to detect a bending operation that causes the first device housing to pivot about the hinge assembly relative to the second device housing, thereby transforming the electronic device into a deformed geometry. In one or more embodiments, the one or more flex sensors can detect initiation of the first device housing pivoting, bending, or deforming about the hinge assembly relative to the second device housing.

In one or more embodiments, the one or more sensors 108 comprise an inertial motion unit. The one or more processors 105 can compare motion sensor readings from the inertial motion unit to detect movement of the electronic device in three-dimensional space. Each inertial motion unit can comprise a combination of one or more accelerometers, one or more gyroscopes, and optionally one or more magnetometers, to determine the orientation, angular velocity, and/or specific force of the electronic device 100. When included in the electronic device 100, these inertial motion units can be used as orientation sensors to measure movement of the device housing 101 in three-dimensional space. Similarly, the inertial motion units can be used as orientation sensors to measure the motion of the device housing 101 in three-dimensional space. The inertial motion units can be used to make other measurements as well.

In one or more embodiments, the other components 107 include a gravity detector. For example, as one or more accelerometers and/or gyroscopes may be used to show vertical orientation, constant, or a measurement of tilt relative to gravity. The other components 107 operable with the one or more processors 105 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

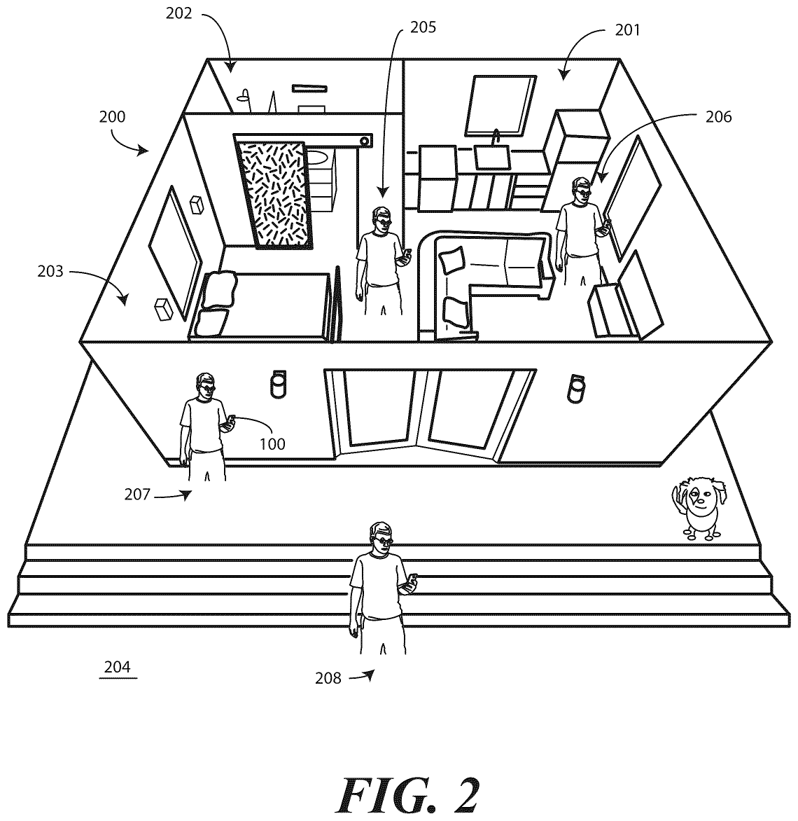

Turning now to FIG. 2, illustrated therein is one explanatory system suitable for using an electronic device 100 configured in accordance with one or more embodiments of the disclosure to determine whether the electronic device 100 is indoors or outdoors. Illustrated in FIG. 2 is a dwelling 200, which is a house in this explanatory embodiment. In other embodiments, the structure defining interior and exterior spaces could be a building, condominium, apartment complex, or other type of structure.

As shown, the dwelling 200 includes walls defining both indoor and outdoor areas. The dwelling 200 includes various structural elements and spaces that are part of the system's operation in determining whether an electronic device 100 is situated indoors or outdoors.

The interior 201 of the dwelling 200 represents the enclosed spaces within the structure. The interior 201 includes multiple rooms and areas where electronic devices may be located. The system leverages the characteristics of the interior 201, such as signal reflections and multipath effects, to determine the indoor status of the electronic device.

The bathroom 202 is one explanatory room within the interior 201. The bathroom 202, like other rooms, contributes to the multipath environment due to the walls and fixtures, which can cause signal reflections. These reflections are used by the system to compute the feedback matrix and determine the indoor status of the electronic device.

The bedroom 203 is another room within the interior 201. The bedroom 203, with walls, furniture, and other objects, creates a multipath environment that affects the signal characteristics. The system uses these characteristics to analyze the feedback matrix transmission interval and ascertain whether the electronic device is indoors.

The exterior 204 of the dwelling 200 represents the outdoor areas surrounding the structure. The exterior 204 includes open spaces where signal reflections are minimal compared to the interior 201. The system uses the reduced multipath effects in the exterior 204 to determine the outdoor status of the electronic device.

The hallway 205 is a passage within the interior 201 that connects different rooms. The hallway 205, with the elongated structure of the hallway 205, can influence signal propagation and reflections. The system considers the signal characteristics in the hallway 205 to enhance the accuracy of the indoor/outdoor determination.

The main room 206 is a central area within the interior 201. The main room 206, often larger and more open than other rooms, presents a multipath environment. The system analyzes the signal reflections in the main room 206 to compute the feedback matrix and determine the indoor status of the electronic device.

The front porch 207 is a transitional area between the interior 201 and the exterior 204. The front porch 207, which is partially enclosed in many situations, can exhibit mixed signal characteristics. The system uses the signal properties in the front porch 207 to refine the determination of whether the electronic device is transitioning between indoor and outdoor environments.

The yard 208 is an open space within the exterior 204. The yard 208, with minimal obstructions, provides a clear environment with fewer signal reflections. The system leverages the signal characteristics in the yard 208 to confirm the outdoor status of the electronic device.

Advantageously, the electronic device 100 of FIG. 2 overcomes the prior art challenges of determining whether the electronic device 100 is situated indoors or outdoors. In one or more embodiments. The electronic device involves considering two metrics, namely, the MCS data rate and the time taken to send a feedback matrix in response to a beamforming report. The MCS data rate serves as an initial filter to assess the quality of the connection. When the MCS data rate exceeds a predefined threshold, the method proceeds to evaluate the feedback matrix transmission interval. This interval is influenced by the number of signal reflections, which tend to be higher in the interior 201 of the dwelling 200 than when the electronic device 100 is situated within the exterior 204 of the dwelling 200. By analyzing these metrics, the electronic device 100 can reliably determine whether it is indoors or outdoors, thereby allowing the electronic device 100 to switch between indoor and outdoor communication channels.

To greatly reduce the potential for false positives, in addition to using the MCS data rate alone, in one or more embodiments the electronic device 100 also considers the feedback matrix transmission interval as a secondary metric. While sampling of the MCS data rate normally occurs as a “sniffer trace” check, embodiments of the disclosure contemplate that then the motion detector determines the electronic device 100 is in motion, the sampling of the MCS rate, as well as analysis of the feedback matrix, can occur more frequently. This approach provides more accurate real-time results and minimizes the loading of the one or more processors of the electronic device 100.

In one or more embodiments, as the user moves around the dwelling 200 holding the electronic device 100, the electronic device 100 performs sniffer trace checks of the MCS rate. Illustrating by example, sampling can occur on the order of every two hundred milliseconds when the electronic device 100 is stationary. However, when the electronic device 100 is moving, the sampling may be more frequent, such as every fifty milliseconds.

In one or more embodiments, the one or more processors of the electronic device 100 determine, from signals from the communication device of the electronic device 100, whether the MCS data rate is within a predefined data range. Illustrating by example, in one or more embodiments when the MCS data rate is within a first range defined between 175 and 225 Mbps, this indicates that the electronic device 100 is situated at the exterior 204 of the dwelling 200. In one or more embodiments, when the MCS data rate is within a second range defined between 475 and 525 Mbps, this indicates that the electronic device 100 is situated within the interior 201 of the dwelling. It should be noted that these ranges are illustrative only, as others will be obvious to those of ordinary skill in the art having the benefit of this disclosure. In one or more embodiments, the indoor MCS data rate is roughly twice the outdoor MCS data rate.

It should also be noted that the detection of the MCS data rate is the gate to trigger the feedback matric transmission interval. Said differently, in one or more embodiments when the MCS data rate is within a predefined data rate range, the one or more processors of the electronic device 100 obtain, from a memory of the electronic device 100, a feedback matrix transmission interval occurring between instances of the communication device transmitting a feedback matrix to an access point.

In one or more embodiments, when the feedback matrix transmission interval exceeds a transmission interval threshold, the one or more processors of the electronic device 100 determine that the electronic device 100 is situated indoors. In one or more embodiments, when the feedback matrix transmission interval is below that transmission interval threshold, the one or more processors determine that the electronic device 100 is situated outdoors. In one or more embodiments, the feedback matrix transmission interval indoors is roughly a quarter of what it is when the electronic device 100 is outdoors.

In one or more embodiments, the transmission interval threshold is between twenty and thirty milliseconds. Illustrating by example, when the feedback matrix transmission interval is on the order of ten milliseconds, the one or more processors can determine that the electronic device 100 is situated outdoors. By contrast, when the feedback matrix transmission interval is on the order of forty milliseconds, the one or more processors can determine that the electronic device 100 is situated outdoors. Thus, in one or more embodiments the transmission interval threshold is between twenty and thirty milliseconds. These values are illustrative only, as others will be obvious to those of ordinary skill in the art having the benefit of this disclosure.

In one or more embodiments, when the one or more processors determine that the electronic device 100 is situated indoors, or alternatively outdoors, the one or more processors store this electronic device situation location in the memory of the electronic device. In one or more embodiments, the one or more processors cause the communication device to switch between indoor and outdoor communication channels to ensure compliance with regulatory requirements and optimize performance. Accordingly, in one or more embodiments the one or more processors cause the communication device to switch communication from one or more communication channels allocated for outdoor communication to one or more other communication channels allocated for indoor communication when (1) the communication data rate is within the predefined data rate range, (2) the feedback matrix transmission interval exceeds the transmission interval threshold, and (3) the communication device is communicating on the one or more communication channels allocated for outdoor communication when the one or more processors compare the feedback matrix transmission interval to the transmission interval threshold.

Other operations can be performed by the electronic device 100 as well. Note that the sampling of the MCS data rate and feedback matrix transmission interval should occur when the motion detector of the electronic device 100 detects that the electronic device 100 is in motion. As shown in FIG. 2, the user holding the electronic device 100 can move through various locations in the dwelling 200, out on the porch 207, and out in the yard 208. In some instances, sampling of the MCS data rate and feedback matrix transmission interval may temporarily pause when the electronic device 100 is stationary. Advantageously, using this method provides more accurate real-time results and has minimal impact on the processor loading of the electronic device 100.

Since the user can move from interior 201 of the dwelling 200 to its exterior, there will be transition points where the feedback matrix transmission interval switches from exceeding the transmission interval threshold indicating that the electronic device is situated indoors to falling below the transmission interval threshold to indicate that the electronic device is situated outdoors. In one or more embodiments, the one or more processors can identify these transitions as a “transition”point between interior and exterior.

In one or more embodiments, when a transition point is detected, the communication device of the electronic device 100 can capture the WLAN and Bluetooth. sup. TM RSSI fingerprint. Alternatively, the one or more processors can capture the location coordinates (x, y, z, and barometer) in a database for these transition points. In one or more embodiments, this information is captured along with ultra-wideband or Bluetooth. sup. TM ranging data.

In one or more embodiments, the one or more processors then build a database stored in the memory of the electronic device 100. In one or more embodiments, this database contains the most frequently used transition/breach points. In one or more embodiments, the one or more processors of the electronic device 100 can then transfer this database to a companion electronic device, examples of which include another mobile device, such as a laptop, tablet, or another phone.

In effect, in one or more embodiments the electronic device 100 conducts ultra-wideband or Bluetooth.sup.™ channel ranging based on indoor/outdoor transition points. However, while the method detection of indoor/outdoor conditions is anonymous, the database is containing the locations and ranging values for other devices to detect without requiring those other devices to employ any indoor to outdoor detection themselves.

Accordingly, in one or more embodiments in response to the one or more processors detecting the electronic device 100 has transitioned from indoor to outdoors, or vice versa, an ultra-wideband component and/or a communication device of the electronic device 100 determines at least one location of at least one other electronic device using one or both of an ultra-wide band ranging process and/or a Bluetooth channel sounding process. In one or more embodiments, the one or more processors of the electronic device 100 store the at least one location with an association to an indoor-to-outdoor transition point or an outdoor-to-indoor transition point in a database stored in a memory of the electronic device 100.

In one or more embodiments, the one or more processors prioritize, within the database, more frequently encountered indoor-to-outdoor transition points above less frequently encountered indoor-to-outdoor transition points and more frequently encountered outdoor-to-indoor transition points above less frequently encountered outdoor-to-indoor transition points. In one or more embodiments the one or more processors cause the communication device to transfer the database to a companion electronic device.

Illustrating by example, when the one or more processors detect a transition point, the one or more processors calculate the relative positions of companion electronic devices using ultra-wideband ranging data, examples of which include time of flight, angle of arrival, and time difference of arrival measurements. The one or more processors can also identify companion electronic devices depicted in the one or more images using image analysis, thereafter correlating locations of the companion electronic devices using the known locations of the wall plates and switch plates also depicted in the one or more images.

In one or more embodiments, based upon the locations and relative positions of companion electronic devices, the one or more processors can generate a database of all companion electronic devices inside and outside the dwelling 200. This allows for precise location tracking of various smart home devices and objects. In one or more embodiments, the system can utilize ultra-wideband ranging techniques, such as time-of-flight (ToF), time-difference-of-arrival (TDoA) and angle-of-arrival (AoA) measurements, to determine the exact location of devices within the home. The electronic device 100 can also work in conjunction with other wireless technologies, such as Bluetooth. sup. TM and Wi-Fi, to enhance the accuracy and reliability of the location tracking process.

Accordingly, in one or more embodiments when the one or more processors determine the electronic device 100 has transitioned from outdoors to indoors, the one or more processors cause the ultra-wideband component to determine a location of at least one other electronic device using an ultra-wideband ranging process. Alternatively, in one or more embodiments when the one or more processors determine the electronic device 100 has transitioned from outdoors to indoors, the one or more processors cause the communication device to determine one or more other locations of one or more other electronic devices situated within the environment of the electronic device using received signal strength indications (RSSI) of one or more communication signals received by the communication device from the one or more other electronic devices. These can be stored in a database and transferred to other electronic devices.

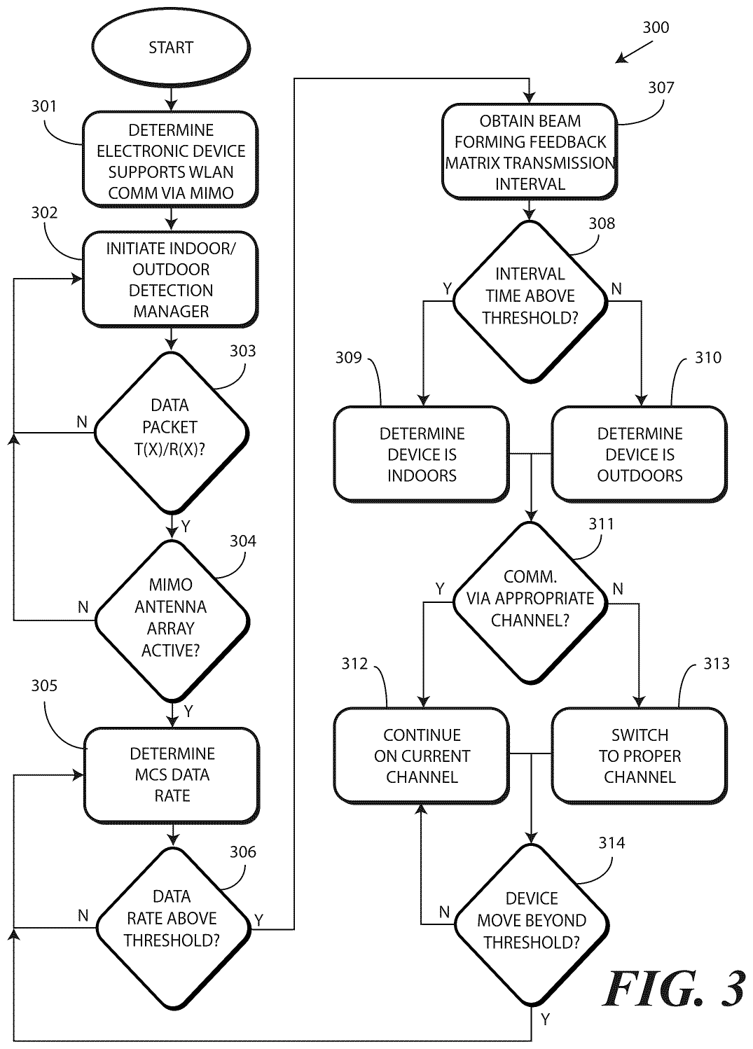

Turning now to FIG. 3, illustrated therein is one explanatory method in accordance with one or more embodiments of the disclosure. The method, denoted as 300, includes several steps and decisions.

Beginning at step 301, the method 300 determines whether an electronic device supports WLAN communication via MIMO communication. Embodiments of the disclosure contemplate that this determination will generally be in the affirmative, as most all modern electronic devices support at least basic MIMO communication. As noted above, MIMO communication uses multiple antennas. When two data signals are sent to an access point, they bounce back with both antennas capturing signal portions. While this allows throughput to nearly become doubled, it allows one or more processors of the electronic device to compare a single antenna to a doubled antenna.

If the electronic device were on the moon, both antennas would look the same because there are no reflections. However, in the real world, there will be lots of reflections. Illustrating by example, in the dwelling (200) of FIG. 2, the signal will be received in multiple parts due to those reflections. To perform channel correction, the feedback matrix must be computed. As noted above, the feedback matrix identifies how many channels are being used, weighting, and other information. The electronic device, provided it supports MIMO communication as determined at step 301, sends this feedback matrix back to the access point so that the access point can correct its beam forming in accordance with the data in the feedback matrix.

In one or more embodiments, when step 301 determines that MIMO communication is supported, the electronic device will also support bean forming. This allows the method 300 of FIG. 3 to use the values found in the feedback matrix to determine whether the electronic device is indoors or outdoors.

To wit, at step 302 the method 300 actuates the indoor/outdoor detection function within the electronic device. Decision 303 then determines whether data packets are being transmitted or received. Where they are, the method 300 moves to decision 304. Otherwise, the method 300 returns to step 302.

In one or more embodiments, decision 304 determines whether the communication engaged in the transaction of the data packets is MIMO communication. Where it is, the method 300 moves to step 305. Otherwise, the method 300 returns to step 302.

At step 305, one or more processors of an electronic device determine the MCS data rate. Decision 306 then comprises determining, by one or more processors from signals from a communication device operable with the one or more processors, whether a communication data rate with an access point exceeds a threshold. In one or more embodiments, the threshold is between 225 Mbps and 475 Mbps. This threshold range is illustrative only, as others will be obvious to those of ordinary skill in the art having the benefit of this disclosure. Where the communication data rate is above the threshold, the method 300 moves to step 307. Otherwise, the method 300 returns to step 305.

At step 307, i.e., when the communication data rate exceeds the threshold, the method 300 comprises obtaining, by the one or more processors from a memory operable with the one or more processors, a feedback matrix transmission interval occurring between instances of the communication device transmitting a feedback matrix to the access point. Decision 308 then comprises determining whether the feedback matrix transmission interval exceeds another threshold. In one or more embodiments, the other threshold between ten and forty milliseconds. This threshold range is illustrative only, as others will be obvious to those of ordinary skill in the art having the benefit of this disclosure.

When decision 308 determines the feedback matrix transmission interval exceeds this other threshold, step 309 comprises determining, by the one or more processors, that the electronic device is situated indoors. By contrast, when decision 308 determines the feedback matrix transmission interval is below the other threshold, step 310 comprises determining, by the one or more processors, that the electronic device is situated outdoors.

Decision 311 then comprises determining, by the one or more processors, whether the communication device is communicating with the access point on one or more communication channels allocated for outdoor communication or on one or more other communication channels allocated for indoor communication. Said differently, decision 311 determines whether the communication device is communicating on the proper communication channels, namely, the channels allocated for outdoor communication when the method 300 passes through step 310 or, alternatively, the one or more other communication channels allocated for indoor communication when the method 300 passes through step 309.

Where this decision is affirmative, the method 300 moves to step 312 where use of the current communication channels continues. By contrast, step 313 comprises switching the communication channels.

Accordingly, in one or more embodiments step 313 comprises, when the feedback matrix transmission interval exceeds the other threshold and the communication device is communicating with the access point on the one or more communication channels allocated for the outdoor communication, causing, by the one or more processors, the communication device to switch communication from the one or more channels allocated for the outdoor communication to the one or more other communication channels allocated for indoor communication. In one or more embodiments, the one or more other communication channels allocated for indoor communication comprise Wi-Fi Direct (P2P) communication channels. By contrast, when the feedback matrix transmission interval falls below the other threshold and the communication device is communicating with the access point on the one or more communication channels allocated for the indoor communication, step 313 comprises causing, by the one or more processors, the communication device to switch communication from the one or more channels allocated for the indoor communication to the one or more other communication channels allocated for outdoor communication.

Decision 314 then comprises determining, by the one or more processors from signals received from a motion detector, whether the electronic device is moving or is stationary. In one or more embodiments, to save power and processor loading, the determining whether the communication data rate with the access point exceeds the threshold at decision 306, and the obtaining the feedback matrix transmission interval at step 307, occurs only where the electronic device is in motion.

In one or more embodiments, decision 314 determines whether the electronic device has moved beyond a predefined threshold distance, such as ten, twenty, or thirty feet, from the location at which decision 308 was previously performed. If so, the method 300 can be repeated, starting at step 305.

Thus, in one or more embodiments decision 314 comprises determining, by the one or more processors from signals received from a location detector, whether the electronic device has moved more than a threshold distance since determining whether the communication data rate with the access point exceeds the threshold. In one or more embodiments, when the electronic device has moved more than the threshold distance since determining whether the communication data rate with the access point exceeds the threshold, decision 306 again determines, by the one or more processors from other signals from the communication device, whether another communication data rate occurring after the electronic device has moved more than the threshold distance exceeds the threshold.

To provide some parameters that can be used to implement the method 300 of FIG. 3, in one or more embodiments the threshold used at decision 306 is defined by an average indoor communication data rate that is about eight times an average outdoor communication data rate. In one or more embodiments, the other threshold used at decision 308 is defined by an average indoor feedback matrix transmission interval that is about four times an average outdoor feedback matrix transmission interval. Other thresholds will be obvious to those of ordinary skill in the art having the benefit of this disclosure.

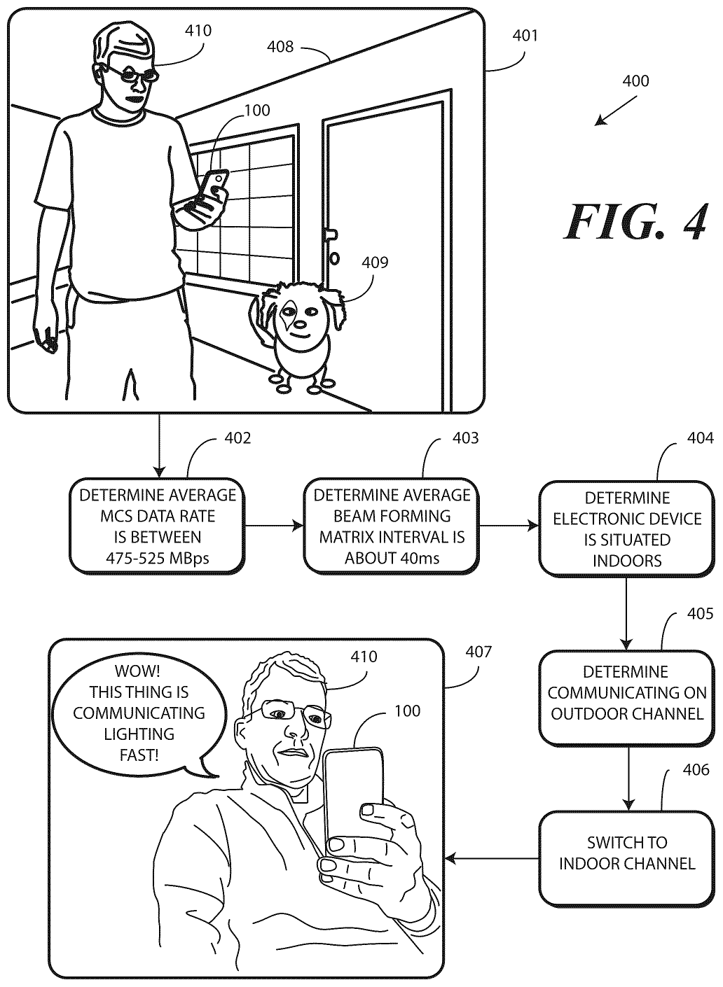

Now that the general constructs of the method 300 of FIG. 3 are understood, some use cases are in order. Turning first to FIG. 4, illustrated therein is a first use case 400. As shown at step 401, a user 410 of an electronic device 100 configured in accordance with one or more embodiments of the disclosure is situated indoors, i.e., inside his home 408, with his trusty dog 409. The electronic device 100 comprises a communication device and one or more processors operable with the communication device.

Additionally, the communication device of the electronic device 100 supports MIMO communication and is electronically communicating with an access point using MIMO communication signals. In one or more embodiments, when the communication device is communicating with a communication data rate exceeding a communication data rate threshold, the one or more processors are configured to determine whether a feedback matrix transmission interval occurring between instances of the communication device transmitting a feedback matrix to the access point indicates that the electronic device is situated indoors or is situated outdoors.

In one or more embodiments, the one or more processors determine that the electronic device is situated indoors when the feedback matrix transmission interval is more than three times an average outdoor feedback matrix transmission interval. In one or more embodiments, the one or more processors are further configured to cause the communication device to switch communication from one of one or more channels allocated for outdoor communication to one or more other communication channels allocated for indoor communication when the feedback matrix transmission interval indicates the electronic device is indoors, or the one or more other channels allocated for indoor communication to the one or more channels allocated for outdoor communication when the feedback matrix transmission interval indicates that the electronic device is outdoors.

At step 402, the one or more processors determine, from signals from a communication device operable with the one or more processors, whether a communication data rate with an access point is within a predefined data rate range. In the illustrative embodiment of FIG. 4, the predefined data range is between 475 Mbps and 525 Mbps. Other predefined ranges will be obvious to those of ordinary skill in the art having the benefit of this disclosure.

When the communication data rate is within the predefined data rate range, step 403 comprises obtaining, by the one or more processors from a memory operable with the one or more processors, a feedback matrix transmission interval occurring between instances of the communication device transmitting a feedback matrix to the access point. Step 403 then comprises determining whether the feedback matrix transmission interval exceeds a transmission interval threshold. In the illustrative embodiment of FIG. 4, the transmission interval threshold is about between twenty and thirty milliseconds, although other transmission interval thresholds will be obvious to those of ordinary skill in the art having the benefit of this disclosure. Thus, a feedback matrix transmission interval of about forty milliseconds exceeds this threshold.

Since the user 410 is indoors at step 401, this means that the feedback matrix transmission interval is exceeds the transmission interval threshold. Accordingly, step 404 comprises determining, by the one or more processors, that the electronic device 100 is situated indoors. In one or more embodiments, step 404 further comprises storing, by the one or more processors, an electronic device situation location in a memory of the electronic device.

In this illustrative example, at step 401 the communication device of the electronic device 100 is communicating with one or more communication channels allocated for outdoor communication. Accordingly, step 405 determines that the feedback matrix transmission interval exceeds the other threshold of step 403, and the communication device is communicating with the access point on the one or more communication channels allocated for the outdoor communication. Step 406 then comprises causing, by the one or more processors, the communication device to switch communication from the one or more channels allocated for the outdoor communication to the one or more other communication channels allocated for indoor communication. At step 407, the user 410 is wowed and amazed by the electronic device 100 and its lightning-fast communication, exclaiming, “Wow! This thing is communicating lighting fast!”

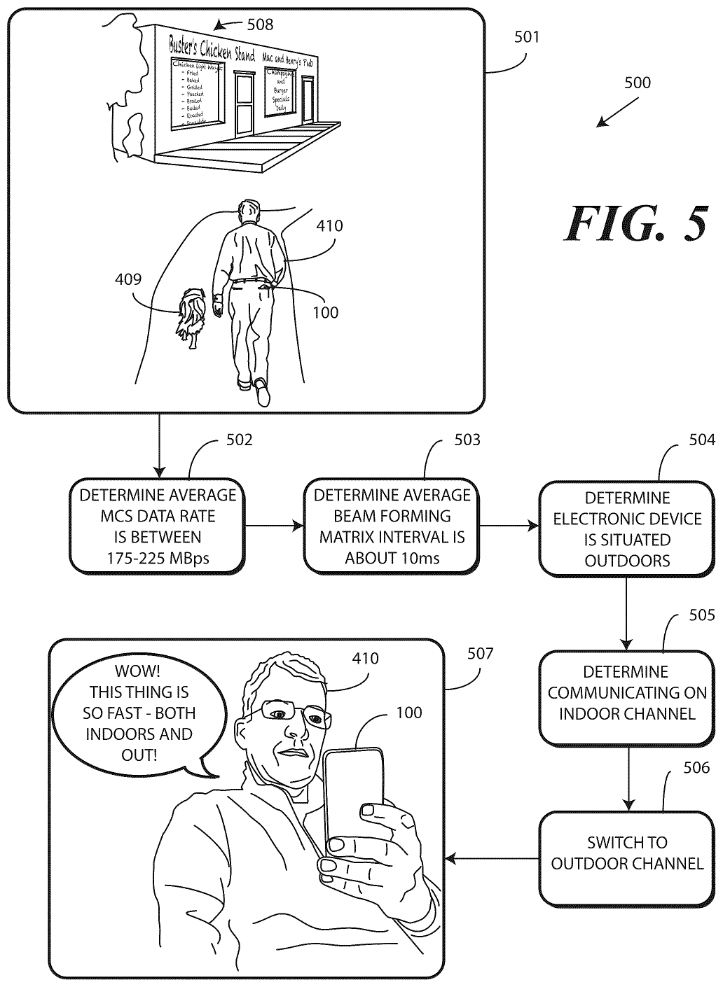

Turning now to FIG. 5, in this use case 500 our friendly user 410 and his dog 409 are heading to Buster's Chicken Stand 508 at step 501. In one or more embodiments, the one or more processors are further configured to again determine whether the feedback matrix transmission interval occurring between instances of the communication device transmitting the feedback matrix to the access point indicates that the electronic device is situated indoors or is situated outdoors when the electronic device moves more than a predefined distance. Moving from the home (408) outdoors qualifies as exceeding the predefined distance.

In this illustrative example, the user 410 and his dog 409 head down a path at step 501 toward Buster's Chicken Stand 508, which is renowned for serving chicken in eight different ways, each dish crafted to high standards. Patrons can savor a variety of tasty dishes such as crispy fried chicken, succulent grilled chicken, tangy barbecue chicken, spicy buffalo chicken wings, savory chicken tenders, aromatic chicken curry, hearty chicken pot pie, and the classic chicken sandwich. Each dish is prepared with high-quality ingredients, ensuring a delightful culinary experience.

Buster's Chicken Stand 508 has received numerous accolades for the cuisine. Food critics and customers alike have praised the restaurant for the flavorful dishes, impeccable service, and inviting atmosphere. The restaurant has been featured in several food magazines and has won awards for the chicken dishes in the region. Additionally, Buster's Chicken Stand 508 is pet-friendly, allowing the user's dog 409 to join the feast. This welcoming environment ensures that both the user 410 and his dog 409 can enjoy a pleasant dining experience together.

At step 502, the one or more processors determine, from signals from a communication device operable with the one or more processors, whether a communication data rate with an access point is within another predefined data rate range. In the illustrative embodiment of FIG. 5, the other predefined data range is between 175 and 225 Mbps. Other predefined ranges will be obvious to those of ordinary skill in the art having the benefit of this disclosure.

When the communication data rate is within the predefined data rate range, step 503 comprises obtaining, by the one or more processors from a memory operable with the one or more processors, a feedback matrix transmission interval occurring between instances of the communication device transmitting a feedback matrix to the access point. Step 503 then comprises determining whether the feedback matrix transmission interval falls below a transmission interval threshold. In the illustrative embodiment of FIG. 5, the transmission interval threshold is about between twenty and thirty milliseconds, although other transmission interval thresholds will be obvious to those of ordinary skill in the art having the benefit of this disclosure. Thus, a feedback matrix transmission interval of about ten milliseconds falls below this threshold.

Since the user 410 is outdoors at step 501, this means that the feedback matrix transmission interval is falls below the transmission interval threshold. Accordingly, step 504 comprises determining, by the one or more processors, that the electronic device 100 is situated outdoors. In one or more embodiments, step 504 further comprises storing, by the one or more processors, an electronic device situation location in a memory of the electronic device.

In this illustrative example, since the user 410 just left his home (408) in FIG. 4 to head to Buster's Chicken Stand 508, at step 501 the communication device of the electronic device 100 is communicating with one or more communication channels allocated for indoor communication. Accordingly, step 505 determines that the feedback matrix transmission interval falls below the other threshold of step 503, and the communication device is communicating with the access point on the one or more communication channels allocated for the indoor communication.

Step 506 then comprises causing, by the one or more processors, the communication device to switch communication from the one or more channels allocated for the indoor communication to the one or more other communication channels allocated for outdoor communication. At step 507, the user 410, who has taken the electronic device 100 from his pocket to snap a picture of his trusty dog 409 as they head to Buster's, is wowed and amazed by the electronic device 100 and its lightning fast communication both indoors and out, exclaiming, “Wow! This thing is so fast - both indoors and out!”

As noted above, in one or more embodiments the electronic device 100 further comprises an ultra-wideband component. When the one or more processors determine the electronic device 100 has transitioned from outdoors to indoors, the one or more processors can cause the ultra-wideband component to determine a location of at least one other electronic device using an ultra-wideband ranging process.

In one or more embodiments, the ultra-wideband component facilitates precise location tracking by measuring the distance between the electronic device and other electronic devices equipped with ultra-wideband components or tags. This process leverages techniques such as time-of-flight (ToF), time-difference-of-arrival (TDoA), and angle-of-arrival (AoA) measurements to achieve high accuracy in determining the relative positions of the devices.

Alternatively, or in combination with the ultra-wideband component, in one or more embodiments when the one or more processors determine the electronic device 100 has transitioned from outdoors to indoors, the one or more processors cause the communication device to determine one or more other locations of one or more other electronic devices situated within the environment of the electronic device using received signal strength indications (RSSI) of one or more communication signals received by the communication device from the one or more other electronic devices.

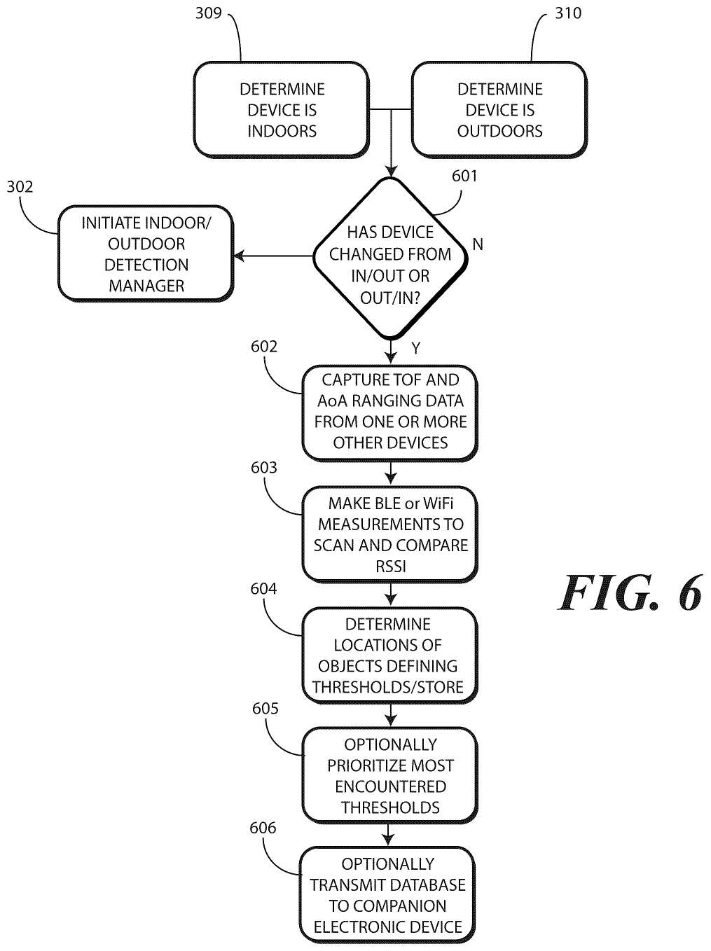

This method allows the electronic device 100 to map the positions of other devices within the vicinity, enhancing the overall spatial awareness and connectivity of the system. The combination of ultra-wideband ranging and RSSI measurements provides a robust framework for accurate and reliable location tracking, ensuring optimal performance and compliance with regulatory requirements. Turning now to FIG. 6, illustrated therein are one or more method steps showing how this can occur.

At step 309 and step 310, determinations as to whether the electronic device is indoors, or outdoors, are made as previously described above with reference to FIG. 3. As noted, there will be transition points where the feedback matrix transmission interval switches from exceeding the transmission interval threshold indicating that the electronic device is situated indoors to falling below the transmission interval threshold to indicate that the electronic device is situated outdoors. In one or more embodiments, the one or more processors can identify these transitions at decision 601 as a “transition” point between interior and exterior. If no transition point is detected, step 302 repeats the location determination process leading to step 309 or step 310.

However, when a transition point is detected, step 602 and step 604 comprise an ultra-wideband component and/or a communication device of the electronic device 100 determines at least one location of at least one other electronic device using one or both of an ultra-wide band ranging process and/or a Bluetooth channel sounding process. Illustrating by example, step 602 can comprise utilizing ultra-wideband ranging techniques, such as time-of-flight (ToF), time-difference-of-arrival (TDoA) and angle-of-arrival (AoA) measurements, to determine the exact location of devices within an environment of the electronic device.

Similarly, step 603 can comprise using other wireless technologies, such as Bluetooth. sup. TM and Wi-Fi, to enhance the accuracy and reliability of the location tracking process. When a transition point is detected, at step 603 the communication device of the electronic device can capture the WLAN and Bluetooth. sup. TM RSSI fingerprint. Alternatively, the one or more processors can capture the location coordinates (x, y, z, and barometer) in a database for these transition points. In one or more embodiments, this information is captured along with ultra-wideband or Bluetooth. sup. TM ranging data.

At step 604, the one or more processors of the electronic device 100 store the at least one location with an association to an indoor-to-outdoor transition point or an outdoor-to-indoor transition point in a database stored in a memory of the electronic device 100. In one or more embodiments, step 604 comprises building a database stored in the memory of the electronic device 100. In one or more embodiments, this database contains the most frequently used transition/breach points.

At optional step 605, the one or more processors prioritize, within the database, more frequently encountered indoor-to-outdoor transition points above less frequently encountered indoor-to-outdoor transition points and more frequently encountered outdoor-to-indoor transition points above less frequently encountered outdoor-to-indoor transition points. In one or more embodiments the one or more processors cause the communication device to transfer the database to a companion electronic device at step 606.

In effect, the method steps of FIG. 6 allow for the use of ultra-wideband or Bluetooth. sup. TM channel ranging based on indoor/outdoor transition points to determine the locations of companion electronic devices. The method steps can occur anonymously. However, the database contains the locations and ranging values for other devices to detect without requiring those other devices to employ any indoor to outdoor detection themselves.

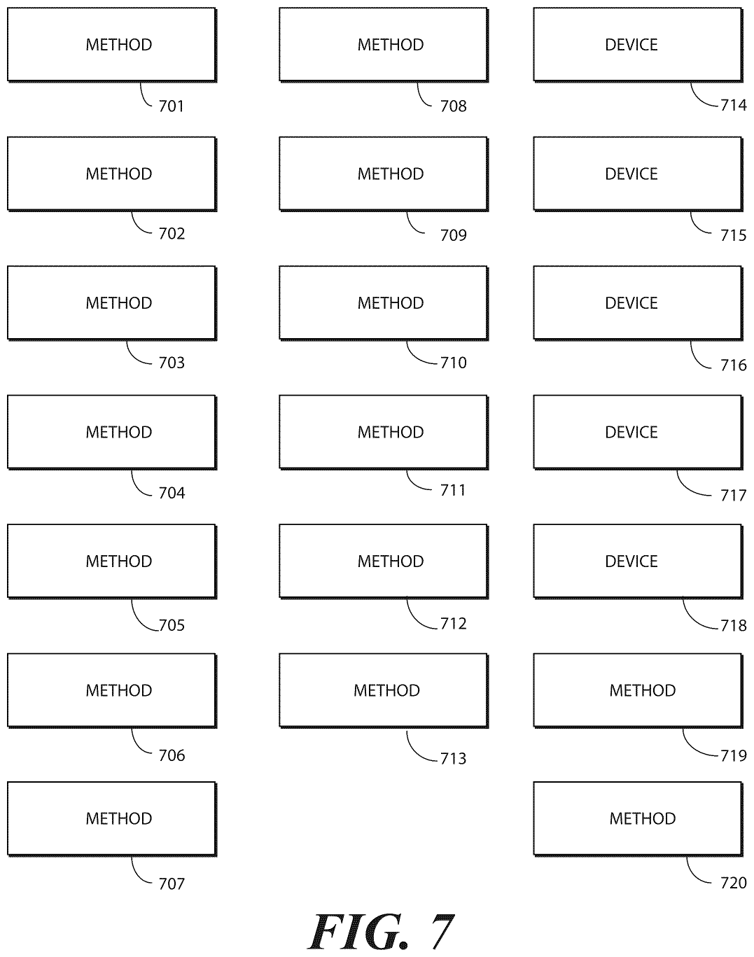

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises determining, by one or more processors from signals from a communication device operable with the one or more processors, whether a communication data rate with an access point exceeds a threshold. At 701, when the communication data rate exceeds the threshold, the method comprises obtaining, by the one or more processors from a memory operable with the one or more processors, a feedback matrix transmission interval occurring between instances of the communication device transmitting a feedback matrix to the access point. At 701, when the feedback matrix transmission interval exceeds another threshold, the method comprises determining, by the one or more processors, that the electronic device is situated indoors.

At 702, the method of 701 further comprises, when the feedback matrix transmission interval is below the another threshold, determining, by the one or more processors, that the electronic device is situated outdoors. At 703, the method of 702 further comprises determining, by the one or more processors, whether the communication device is communicating with the access point on one or more communication channels allocated for outdoor communication or on one or more other communication channels allocated for indoor communication.

At 704, the method of 703 further comprises, when the feedback matrix transmission interval exceeds the another threshold and the communication device is communicating with the access point on the one or more communication channels allocated for the outdoor communication, causing, by the one or more processors, the communication device to switch communication from the one or more channels allocated for the outdoor communication to the one or more other communication channels allocated for indoor communication. At 705, the one or more other communication channels allocated for indoor communication at 704 comprise Wi-Fi Direct (P2P) communication channels.

At 706, the method of 704 further comprises, when the feedback matrix transmission interval falls below the another threshold and the communication device is communicating with the access point over the one or more communication channels allocated for indoor communication, causing, by the one or more processors, the communication device to switch the communication from the one or more other channels allocated for indoor communication to the one or more channels allocated for outdoor communication.

At 707, the method of 701 further comprises determining, by the one or more processors from signals received from a motion detector, whether the electronic device is moving or is stationary. At 707, the determining whether the communication data rate with the access point exceeds the threshold and the obtaining the feedback matrix transmission interval occurs only where the electronic device is in motion.

At 708, the method of 701 further comprises determining, by the one or more processors from signals received from a location detector, whether the electronic device has moved more than a threshold distance since determining whether the communication data rate with the access point exceeds the threshold. At 708, when the electronic device has moved more than the threshold distance since determining whether the communication data rate with the access point exceeds the threshold, the method comprises again determining, by the one or more processors from other signals from the communication device, whether another communication data rate occurring after the electronic device has moved more than the threshold distance exceeds the threshold.

At 709, the threshold of 701 is defined by an average indoor communication data rate that is about eight times an average outdoor communication data rate and the another threshold is defined by an average indoor feedback matrix transmission interval that is about four times an average outdoor feedback matrix transmission interval.

At 710, the method of 701 further comprises, in response to the one or more processors detecting the electronic device has transitioned from indoor to outdoors, or vice versa: determining, with at least one of an ultra-wideband component of the electronic device and/or a communication device of the electronic device, at least one location of at least one other electronic device using one or both of an ultra-wide band ranging process and/or a Bluetooth channel sounding process and storing, by the one or more processors, the at least one location with an association to an indoor-to-outdoor transition point or an outdoor-to-indoor transition point in a database stored in a memory of the electronic device.

At 711, the method of 710 further comprises prioritizing, by the one or more processors within the database, more frequently encountered indoor-to-outdoor transition points above less frequently encountered indoor-to-outdoor transition points and more frequently encountered outdoor-to-indoor transition points above less frequently encountered outdoor-to-indoor transition points. At 712, the method of 710 further comprises causing, by the one or more processors, the communication device to transfer the database to a companion electronic device.

At 713, an electronic device comprises a communication device and one or more processors operable with the communication device. At 713, when the communication device supports MIMO communication and is electronically communicating with an access point with a communication data rate exceeding a communication data rate threshold, the one or more processors are configured to determine whether a feedback matrix transmission interval occurring between instances of the communication device transmitting a feedback matrix to the access point indicates that the electronic device is situated indoors or is situated outdoors. At 714, the one or more processors of 713 determine that the electronic device is situated indoors when the feedback matrix transmission interval is more than three times an average outdoor feedback matrix transmission interval.

At 715, the electronic device of 713 further comprises an ultra-wideband component. At 715, when the one or more processors determine the electronic device has transitioned from outdoors to indoors the one or more processors cause the ultra-wideband component to determine a location of at least one other electronic device using an ultra-wideband ranging process.

AT 716, when the one or more processors of 713 determine the electronic device has transitioned from outdoors to indoors the one or more processors cause the communication device to determine one or more other locations of one or more other electronic devices situated within the environment of the electronic device using RSSI of one or more communication signals received by the communication device from the one or more other electronic devices.

At 717, the one or more processors of 713 are further configured to cause the communication device to switch communication from one of: one or more channels allocated for outdoor communication to one or more other communication channels allocated for indoor communication when the feedback matrix transmission interval indicates the electronic device is indoors; or the one or more other channels allocated for indoor communication to the one or more channels allocated for outdoor communication when the feedback matrix transmission interval indicates that the electronic device is outdoors.

At 718, the one or more processors of 713 are further configured to again determine whether the feedback matrix transmission interval occurring between instances of the communication device transmitting the feedback matrix to the access point indicates that the electronic device is situated indoors or is situated outdoors when the electronic device moves more than a predefined distance.

At 719, a method in an electronic device comprises determining, by one or more processors from signals from a communication device operable with the one or more processors, whether a communication data rate with an access point is within a predefined data rate range. At 719, when the communication data rate is within the predefined data rate range, the method comprises obtaining, by the one or more processors from a memory operable with the one or more processors, a feedback matrix transmission interval occurring between instances of the communication device transmitting a feedback matrix to the access point.

At 719, when the feedback matrix transmission interval is exceeds a transmission interval threshold, the method comprises determining, by the one or more processors, that the electronic device is situated indoors. At 719, when the feedback matrix transmission interval is below the transmission interval threshold, the method comprises determining by the one or more processors, that the electronic device is situated outdoors. At 719, the method comprises storing, by the one or more processors, an electronic device situation location in a memory of the electronic device.

At 720, the method of 719 further comprises causing, by the one or more processors, the communication device to switch communication from one or more communication channels allocated for outdoor communication to one or more other communication channels allocated for indoor communication when: the communication data rate is within the predefined data rate range; the feedback matrix transmission interval is exceeds the transmission interval threshold; and the communication device is communicating on the one or more communication channels allocated for outdoor communication when the one or more processors compare the feedback matrix transmission interval to the transmission interval threshold.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment an electronic device configured in accordance with one or more embodiments of the disclosure comprises a communication device and one or more processors operable with the communication device. When the communication device supports MIMO communication and is electronically communicating with an access point with a communication data rate exceeding a communication data rate threshold, the one or more processors are configured to determine whether a feedback matrix transmission interval occurring between instances of the communication device transmitting a feedback matrix to the access point indicates that the electronic device is situated indoors or is situated outdoors.

In another embodiment, the electronic device further includes an ultra-wideband component. When the one or more processors determine the electronic device has transitioned from outdoors to indoors, the one or more processors cause the ultra-wideband component to determine a location of at least one other electronic device using an ultra-wideband ranging process.

In yet another embodiment, the one or more processors cause the communication device to determine one or more other locations of one or more other electronic devices situated within the environment of the electronic device using received signal strength indications (RSSI) of one or more communication signals received by the communication device from the one or more other electronic devices.

Additionally, in one embodiment, the one or more processors are further configured to cause the communication device to switch communication from one or more channels allocated for outdoor communication to one or more other communication channels allocated for indoor communication when the feedback matrix transmission interval indicates the electronic device is indoors. Conversely, the one or more processors can cause the communication device to switch communication from the one or more other channels allocated for indoor communication to the one or more channels allocated for outdoor communication when the feedback matrix transmission interval indicates that the electronic device is outdoors.

In another embodiment, the one or more processors are further configured to again determine whether the feedback matrix transmission interval occurring between instances of the communication device transmitting the feedback matrix to the access point indicates that the electronic device is situated indoors or is situated outdoors when the electronic device moves more than a predefined distance. This ensures that the electronic device continually switches between indoor and outdoor communication channels properly as the device moves, thereby ensuring compliance with regulatory requirements and optimizing performance.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
determining, by one or more processors from signals from a communication device operable with the one or more processors, whether a communication data rate with an access point exceeds a threshold;
when the communication data rate exceeds the threshold, obtaining, by the one or more processors from a memory operable with the one or more processors, a feedback matrix transmission interval occurring between instances of the communication device transmitting a feedback matrix to the access point; and
when the feedback matrix transmission interval exceeds another threshold, determining, by the one or more processors, that the electronic device is situated indoors.

2. The method of claim 1, further comprising, when the feedback matrix transmission interval is below the another threshold, determining, by the one or more processors, that the electronic device is situated outdoors.

3. The method of claim 2, further comprising determining, by the one or more processors, whether the communication device is communicating with the access point on one or more communication channels allocated for outdoor communication or on one or more other communication channels allocated for indoor communication.

4. The method of claim 3, further comprising, when the feedback matrix transmission interval exceeds the another threshold and the communication device is communicating with the access point on the one or more communication channels allocated for the outdoor communication, causing, by the one or more processors, the communication device to switch communication from the one or more channels allocated for the outdoor communication to the one or more other communication channels allocated for indoor communication.

5. The method of claim 4, wherein the one or more other communication channels allocated for indoor communication comprise Wi-Fi Direct (P2P) communication channels.

6. The method of claim 4, further comprising, when the feedback matrix transmission interval falls below the another threshold and the communication device is communicating with the access point over the one or more communication channels allocated for indoor communication, causing, by the one or more processors, the communication device to switch the communication from the one or more other communication channels allocated for indoor communication to the one or more channels allocated for outdoor communication.

7. The method of claim 1, further comprising determining, by the one or more processors from signals received from a motion detector, whether the electronic device is moving or is stationary, wherein the determining whether the communication data rate with the access point exceeds the threshold and the obtaining the feedback matrix transmission interval occurs only where the electronic device is in motion.

8. The method of claim 1, further comprising, determining, by the one or more processors from signals received from a location detector, whether the electronic device has moved more than a threshold distance since determining whether the communication data rate with the access point exceeds the threshold, and when the electronic device has moved more than the threshold distance since determining whether the communication data rate with the access point exceeds the threshold, again determining, by the one or more processors from other signals from the communication device, whether another communication data rate occurring after the electronic device has moved more than the threshold distance exceeds the threshold.

9. The method of claim 1, wherein the threshold is defined by an average indoor communication data rate that is about eight times an average outdoor communication data rate and the another threshold is defined by an average indoor feedback matrix transmission interval that is about four times an average outdoor feedback matrix transmission interval.

10. The method of claim 1, further comprising, in response to the one or more processors detecting the electronic device has transitioned from indoor to outdoors, or vice versa:
determining, with at least one of an ultra-wideband component of the electronic device and/or a communication device of the electronic device, at least one location of at least one other electronic device using one or both of an ultra-wide band ranging process and/or a Bluetooth channel sounding process; and
storing, by the one or more processors, the at least one location with an association to an indoor-to-outdoor transition point or an outdoor-to-indoor transition point in a database stored in a memory of the electronic device.

11. The method of claim 10, further comprising prioritizing, by the one or more processors within the database, more frequently encountered indoor-to-outdoor transition points above less frequently encountered indoor-to-outdoor transition points and more frequently encountered outdoor-to-indoor transition points above less frequently encountered outdoor-to-indoor transition points.

12. The method of claim 10, further comprising causing, by the one or more processors, the communication device to transfer the database to a companion electronic device.

13. An electronic device, comprising:
a communication device; and
one or more processors operable with the communication device;
wherein when the communication device supports multiple input/multiple output (MIMO) communication and is electronically communicating with an access point with a communication data rate exceeding a communication data rate threshold, the one or more processors are configured to determine whether a feedback matrix transmission interval occurring between instances of the communication device transmitting a feedback matrix to the access point indicates that the electronic device is situated indoors or is situated outdoors.

14. The electronic device of claim 13, wherein the one or more processors determine that the electronic device is situated indoors when the feedback matrix transmission interval is more than three times an average outdoor feedback matrix transmission interval.

15. The electronic device of claim 13, further comprising an ultra-wideband component, wherein when the one or more processors determine the electronic device has transitioned from outdoors to indoors the one or more processors cause the ultra-wideband component to determine a location of at least one other electronic device using an ultra-wideband ranging process.

16. The electronic device of claim 13, wherein when the one or more processors determine the electronic device has transitioned from outdoors to indoors the one or more processors cause the communication device to determine one or more other locations of one or more other electronic devices situated within an environment of the electronic device using received signal strength indications (RSSI) of one or more communication signals received by the communication device from the one or more other electronic devices.

17. The electronic device of claim 13, wherein the one or more processors are further configured to cause the communication device to switch communication from one of:
one or more channels allocated for outdoor communication to one or more other communication channels allocated for indoor communication when the feedback matrix transmission interval indicates the electronic device is indoors; or
the one or more other communication channels allocated for indoor communication to the one or more channels allocated for outdoor communication when the feedback matrix transmission interval indicates that the electronic device is outdoors.

18. The electronic device of claim 13, wherein the one or more processors are further configured to again determine whether the feedback matrix transmission interval occurring between instances of the communication device transmitting the feedback matrix to the access point indicates that the electronic device is situated indoors or is situated outdoors when the electronic device moves more than a predefined distance.

19. A method in an electronic device, the method comprising:
determining, by one or more processors from signals from a communication device operable with the one or more processors, whether a communication data rate with an access point is within a predefined data rate range;
when the communication data rate is within the predefined data rate range, obtaining, by the one or more processors from a memory operable with the one or more processors, a feedback matrix transmission interval occurring between instances of the communication device transmitting a feedback matrix to the access point; and
when the feedback matrix transmission interval is exceeds a transmission interval threshold, determining, by the one or more processors, that the electronic device is situated indoors; and
when the feedback matrix transmission interval is below the transmission interval threshold, determining by the one or more processors, that the electronic device is situated outdoors; and
storing, by the one or more processors, an electronic device situation location in a memory of the electronic device.

20. The method of claim 19, further comprising causing, by the one or more processors, the communication device to switch communication from one or more communication channels allocated for outdoor communication to one or more other communication channels allocated for indoor communication when:
the communication data rate is within the predefined data rate range;
the feedback matrix transmission interval exceeds the transmission interval threshold; and
the communication device is communicating on the one or more communication channels allocated for outdoor communication when the one or more processors compare the feedback matrix transmission interval to the transmission interval threshold.
